(19) United States
(12) Patent Application Publication
(10) Pub. No.: US 2026/0275984 A1
(43) Pub. Date: Sep. 17, 2026

(54) VACUUM PUMP

(71) Applicant: Edwards Limited, Burgess Hill, Sussex (GB)

(72) Inventors: Michael Henry North, Burgess Hill, Sussex (GB); Cainan Long, Burgess Hill, Sussex (GB); Matthew Richard Wickes, Burgess Hill, Sussex (GB); Sivabalan Kailasam, Burgess Hill, Sussex (GB); Wonsik Song, Cheonan-si, Chungcheongnam-do (KR); YoungHyun You, Cheonan-si, Chungcheongnam-do (KR); YoungMin Kim, Cheonan-si, Chungcheongnam-do (KR)

(21) Appl. No.: 19/472,466

(22) PCT Filed: Mar. 28, 2024
(86) PCT No.: PCT/GB2024/050883

§ 371 Date: Oct. 3, 2025

(30) Foreign Application Priority Data
Apr. 5, 2023 (GB) 2305056.0
Jul. 12, 2023 (GB) 2310702.2

(51) Int. Cl. F04C 18/12; F04C 25/02; F04C 29/04

(52) U.S. Cl. CPC F04C 18/126; F04C 25/02; F04C 29/04; F04C 2220/10; F05C 2201/021; F05C 2201/046; F05C 2251/048

(57) ABSTRACT

A vacuum pump comprising: a stator, the stator comprising one or more stator walls defining a pumping chamber; and a heat transfer device coupled to the one or more stator walls, the heat transfer device comprising: a thermally conductive body; and a conduit through the thermally conductive body and through which, in use, a purge gas is passed whereby to heat the purge gas.

### CROSS-REFERENCE OF RELATED APPLICATION

This application is a Section 371 National Stage Application of International Application No. PCT/GB2024/050883, filed Mar. 28, 2024, and published as WO 2024/209194 A1 on Oct. 10, 2024, the content of which is hereby incorporated by reference in its entirety and which claims priority of British Application No. 2305056.0, filed Apr. 5, 2023 and British Application No. 2310702.2, filed Jul. 12, 2023.

### FIELD

The present invention relates to vacuum pumps.

### BACKGROUND

Vacuum pumps are used in various technical processes to pump process gases out of process chambers, thereby to create low-pressure conditions for the respective processes. The process gas may contain by-products of the processes. The by-products may proceed into the pumping chamber of the vacuum pump where they may solidify or condense. The solidified by-products may settle on surfaces within the pumping chamber, such as interior walls of the pumping chamber and peripheral surfaces of the rotors. The deposited by-products may constrict the gap situated between the rotors. The deposited by-products may lead to reduced pumping efficiency, bearing damage and, ultimately, to the failure of the vacuum pump.

It is known to use purge or flushing gas to prevent or oppose build-up of solidified by-products. The purge gas may be discharged into the pump chamber via a purge gas line during the operation of the pump. Preferably, the purge gas is delivered at high speed, for example, via a nozzle. The flow of purge gas prevents the settling of solid particles within the pump chamber and facilitate in the conveyance of said solid particles out of the pumping chamber.

It is known to use mechanical booster pumps in conjunction with vacuum pumps. One or more mechanical booster pumps may be mechanically coupled to the vacuum pump, for example at the inlet of the vacuum pump, such that, in operation, the mechanical booster pump increases the pressure of the fluid entering the vacuum pump.

The discussion above is merely provided for general background information and is not intended to be used as an aid in determining the scope of the claimed subject matter. The claimed subject matter is not limited to implementations that solve any or all disadvantages noted in the background.

### SUMMARY

Heating the stator of the vacuum pump may prevent condensation and deposition of the by-products within the pumping chamber.

The present inventors have realised, however, that the introduction of a purge gas into the pumping chamber may lower the temperature within the pumping chamber and/or the temperature of the stator walls, thereby causing by-products present within the pumping chamber to condense. The present inventors have further realised that pre-heating the purge gas prior to its introduction into a pumping chamber tends to reduce the cooling effect of the purge gas introduction, thereby reducing condensation and deposition of by-products within the pumping chamber.

The present inventors have further realised that heat exchangers may be accommodated in the walls of pump stators, such as the stators of booster pumps, and may be used to pre-heat a purge gas prior to that purge gas being introduced into the pumping chamber of a vacuum pump, e.g. a further pump downstream of the booster pump. The present inventors have further realised that heaters may also be accommodated in the walls of pump stators, such as the stators of booster pumps, and may be used to heat the stator walls, thereby to heat the pumping chamber of the booster pump as well as the purge gas flowing through the heat exchanger.

In a first aspect, there is provided a vacuum pump stator comprising one or more walls defining a pumping chamber, and a heat exchanger comprising a conduit through at least one of the one or more walls which, in use, a purge gas is passed through whereby to heat the purge gas.

The conduit may comprise a conduit inlet, and a conduit outlet. The conduit inlet may be located at an external surface of the one or more walls. The conduit outlet may be located at an external surface of the one or more walls. The conduit connected between the conduit inlet and conduit outlet may be separated from the pumping chamber by the at least one of the one or more walls.

The one or more walls may comprise a first wall, a second wall opposite to the first wall, and one or more further walls disposed between the first wall and the second wall. The vacuum pump stator may further comprise a pumping chamber inlet defined in the first wall, and a pumping chamber outlet defined in the second wall. The conduit may be embedded in or integrally formed with the one or more further walls.

The vacuum pump stator may further comprise one or more heaters configured to heat at least a portion of the one or more walls.

The one or more heaters may be at least partially embedded in the one or more walls.

The conduit may be defined by a channel formed on an external surface of the one or more walls, and a cover covering at least a portion of the channel and fixedly attached to the one or more walls.

The conduit may be a convoluted conduit.

In a further aspect, there is provided a vacuum pump comprising a stator according to any preceding aspect, one or more rotors arranged in the pumping chamber, and one or more shafts extending at least partially though the pumping chamber. The one or more rotors are fixed to a respective one of the one or more shafts.

In a further aspect, there is provided a system comprising the vacuum pump of any preceding aspect, and a purge gas source configured to supply the purge gas into the conduit.

The pumping chamber may comprise a first pumping chamber inlet and a first pumping chamber outlet. The system may further comprise a further vacuum pump. The further vacuum pump may comprise a further pumping chamber. The further pumping chamber may comprise a second pumping chamber inlet and a second pumping chamber outlet. The first pumping chamber outlet may be coupled to the second pumping chamber inlet such that, in use, a fluid is pumped from the pumping chamber to the further pumping chamber. The heat exchanger may be coupled to the further pumping chamber such that, in use, the heated purge gas is supplied into the further pumping chamber.

The vacuum pump may be a booster pump.

In a further aspect, there is provided a method comprising: providing a vacuum pump, the vacuum pump being in accordance with any preceding aspect; pumping, using the vacuum pump, a fluid, the fluid being pumped through the pumping chamber of the vacuum pump; and causing a purge gas to flow through the conduit of the heat exchanger. As the purge gas flows through the conduit, heat is transferred to the purge gas from the one or more walls thereby to heat the purge gas.

The purge gas may be nitrogen.

The method may further comprise heating, by one or more heaters, at least a portion of the one or more walls.

The method may further comprise outputting, to a further vacuum pump, from the heat exchanger, the heated purge gas.

In a further aspect, there is provided a vacuum pump comprising a stator and a heat transfer device. The stator comprises one or more stator walls defining a pumping chamber. The heat transfer device is coupled to the one or more stator walls. The heat transfer device comprises a thermally conductive body and a conduit through the thermally conductive body. The conduit is a conduit through which, in use, a purge gas is passed whereby to heat the purge gas.

The heat transfer device may be attached (e.g. by fasteners) to an external surface of the one or more stator walls.

The conduit may comprise a pipe that is embedded within the thermally conductive body. The pipe may be partially embedded within the thermally conductive body, e.g. the pipe may be press fit into a groove formed in a surface of the thermally conductive body. Alternatively, the pipe may be wholly embedded within the thermally conductive body, e.g. the pipe may be cast into a solid body of the thermally conductive body. The pipe may be a stainless-steel pipe.

The thermally conductive body may be a plate or block of a thermally conductive material, such as a metal. The thermally conductive body may comprise aluminium, e.g. the thermally conductive body may be a plate substantially of aluminium or an aluminium alloy.

The conduit may be a convoluted, meandering, or serpentine conduit.

The heat transfer device may further comprise one or more heaters embedded therein. The heaters may be elongate heaters, each contained in respective bores through the thermally conductive material. The heat transfer device may comprise a plurality of heaters arranged spaced-apart from one another. The conduit may be a convoluted conduit passing through one or more spaces between the heaters. The one or more heaters and the conduit may be arranged as a common layer or plane within the thermally conductive material. Alternatively, the heater(s) and the conduit may be arranged in different respective layers or planes within the thermally conductive material, the planes or layers being substantially parallel with each other.

The heat transfer device may further comprise a further conduit through the thermally conductive body and through which, in use, a cooling fluid (e.g., water) is passed whereby to cool the thermally conductive body. The further conduit may be a convoluted, meandering, or serpentine conduit.

The heat transfer device may comprise a further conduit through the thermally conductive body arranged to receive a cooling fluid (and which in use may receive a cooling fluid so that the cooling fluid passes through the thermally conductive body to provide cooling thereto). The further conduit may be arranged in the thermally conductive body as a first layer (e.g., substantially in a first plane). The heat transfer device may comprise a plurality of heaters arranged in the thermally conductive body as a second layer (e.g., substantially in a second plane). The second layer may be substantially parallel with the first layer. The conduit may be arranged in the thermally conductive body as a third layer (e.g., substantially in a third plane). The third layer may be substantially parallel with the first layer and the second layer. The third layer may be disposed between the first layer and the second layer. Alternatively, the second layer may be disposed between the first layer and the third layer.

The conduit may comprise an inlet at or proximate to a first side of the heat transfer device, and an outlet at or proximate to a second side of the heat transfer device, the second side being opposite to the first side. The first side may correspond to a low vacuum side of the vacuum pump and the second side may correspond to a high vacuum side of the vacuum pump. Alternatively, the first side may correspond to a high vacuum side of the vacuum pump and the second side may correspond to a low vacuum side of the vacuum pump. Said another way, the stator may comprise a high-vacuum end and a low vacuum end, and the conduit may comprise an inlet at or proximate to one of the high-vacuum end or the low vacuum end, and an outlet at or proximate to the other one of the high-vacuum end or the low vacuum end.

In a further aspect, there is provided a system comprising the vacuum pump of any preceding aspect, and a purge gas source configured to supply the purge gas into the conduit.

In a further aspect, there is provided a method comprising: providing a vacuum pump, the vacuum pump being in accordance with any preceding aspect; pumping, using the vacuum pump, a fluid, the fluid being pumped through the pumping chamber of the vacuum pump; and causing a purge gas to flow through the conduit of the heat transfer device. As the purge gas flows through the conduit, heat is transferred to the purge gas from the stator via the thermally conductive body, thereby to heat the purge gas.

Summary is provided to introduce a selection of concepts in a simplified form that are further described in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a schematic illustration (not to scale) of a vacuum pumping system;

FIG. 2 is a schematic illustration (not to scale) showing an exploded perspective view of a first stator of the first vacuum pump;

FIG. 3 is a process flow chart showing certain steps of a process performed by the vacuum pumping system;

FIG. 4 is a schematic illustration (not to scale) showing a perspective view of a vacuum pump comprising a heat transfer device;

FIGS. 5 and 6 are schematic illustrations (not to scale) showing the heat transfer device;

FIG. 7 is a schematic illustration (not to scale) showing a further heat transfer device;

FIG. 8 is a schematic illustration (not to scale) showing a yet further heat transfer device; and

FIG. 9 is a schematic illustration (not to scale) showing a cross section of a yet further heat transfer device.

### DETAILED DESCRIPTION

It will be appreciated that relative terms such as above and below, horizontal and vertical, top and bottom, front and back, and so on, are used herein merely for ease of reference to the Figures, and these terms are not limiting as such, and any two differing directions or positions and so on may be implemented rather than truly above and below, horizontal and vertical, top and bottom, and so on.

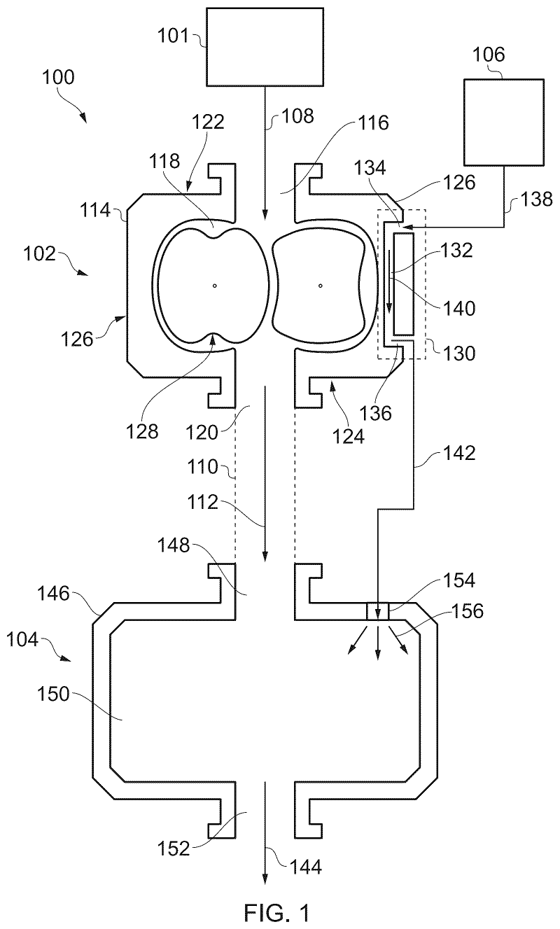

FIG. 1 is a schematic illustration (not to scale) of a vacuum pumping system 100.

The vacuum pumping system 100 comprises a facility 101, a first vacuum pump 102, a second vacuum pump 104, and a purge gas source 106.

The facility 101 may be any appropriate type of facility, for example a semiconductor fabrication facility. The facility 101 is coupled to a vacuum pumping system comprising the first vacuum pump 102 and the second vacuum pump 104. The vacuum pumping system 100 is configured to establish a vacuum or low-pressure environment at the facility 101 by drawing gas (for example, air or process gases) from the facility 101.

The first vacuum pump 102 is a mechanical booster pump. The first vacuum pump 102 may be any appropriate type of booster pump such as a Roots-type or Roots vacuum pump. The first vacuum pump 102 may be a positive displacement pump. The first vacuum pump 102 is operatively coupled between the facility 101 and the second vacuum pump 104. The first vacuum pump 102 is configured to pump fluid (e.g. gas) out of the facility 101, as indicated in FIG. 1 by an arrow and reference numeral 108. The first vacuum pump 102 is further configured to pump that fluid, via a fluid line 110, to the second vacuum pump 104, as indicated in FIG. 1 by an arrow and reference numeral 112. The first vacuum pump 102 is configured to increase the pressure of the pumped fluid entering the second vacuum pump 104. Such operation of the first vacuum pump 102 tends to increase the pumping effectiveness of the second vacuum pump 104.

The first vacuum pump 102 comprises a first housing or stator 114. The first stator 114 comprises one or more walls which define a first fluid inlet 116, a first pumping chamber 118, and a first fluid outlet 120.

In particular, in this embodiment, the first stator 114 comprises a first or top wall 122, a second or bottom wall 124 opposite to the first wall 122, and one or more further walls, or side walls, 126 disposed between the first wall 122 and the second wall 124. The first fluid inlet 116 is formed through the first wall 122. The first fluid outlet 120 is formed through the second wall 124.

The first vacuum pump 102 further comprises a first pumping means 128 located within the first pumping chamber 118. The first pumping means 128 may be any appropriate type of pumping means and may include, for example, one or more rotors such as a plurality of intermeshing or cooperating rotors. The one or more rotors may be fixed to respective shafts extending at least partially though the first pumping chamber 118. The shafts, and thereby the rotors, may be rotated by any appropriate means, such as an electric motor, whereby to pump fluid through the first pumping chamber 118.

The first pumping chamber 118 (and the first pumping means 128 therein) are connected between the first fluid inlet 116 and first fluid outlet 120 such that, in operation, the fluid is pumped, by the first pumping means 128 into the first fluid inlet 116, from the first fluid inlet 116 to the first fluid outlet 120, and out of the first fluid outlet 120.

The first vacuum pump 102 further comprises a heat exchanger 130. The heat exchanger 130 comprises a conduit 132 through (e.g., embedded in or integrally formed with) at least one of the one or more walls of the first stator 114. In particular, in this embodiment, the conduit 132 is embedded in or integrally formed with the one or more further walls 126. The conduit 132 may be wholly within the one or more further walls 126.

In this embodiment, the conduit 132 comprises a conduit inlet 134 and a conduit outlet 136. The conduit inlet 134 is located at an external surface of the first stator 114. In particular, in this embodiment, the conduit inlet 134 is located at an external surface of the one or more further walls 126. The conduit outlet 136 is located at an external surface of the first stator 114. In particular, in this embodiment, the conduit outlet 136 is located at an external surface of the one or more further walls 126.

The conduit inlet 134 is coupled to the purge gas source 106 such that, in operation, a purge gas is received at the conduit inlet 134 from the purge gas source 106, as indicated in FIG. 1 by an arrow and the reference numeral 138. The conduit 132 is configured to convey the received purge gas therethrough, from the conduit inlet 134 to the conduit outlet 136, as indicated in FIG. 1 by an arrow and the reference numeral 140. The conduit outlet 136 is coupled to the second vacuum pump 104 such that, in operation, purge gas exiting the conduit 132 of the heat exchanger 130 via the conduit outlet 136 is conveyed to the second vacuum pump 104, as indicated in FIG. 1 by an arrow and the reference numeral 142.

In this embodiment, the conduit 132, connected between the conduit inlet 134 and conduit outlet 136, is separated from the pumping chamber 118 by the walls of the first stator 114. In other words, within the confines or boundary of the first stator 114, in this embodiment, the conduit 132 is fluidly isolated or independent from the first pumping chamber 118. Thus, in this embodiment, fluid cannot flow between from the conduit 132 to the first pumping chamber 118, or vice versa, through the walls of the first stator 114.

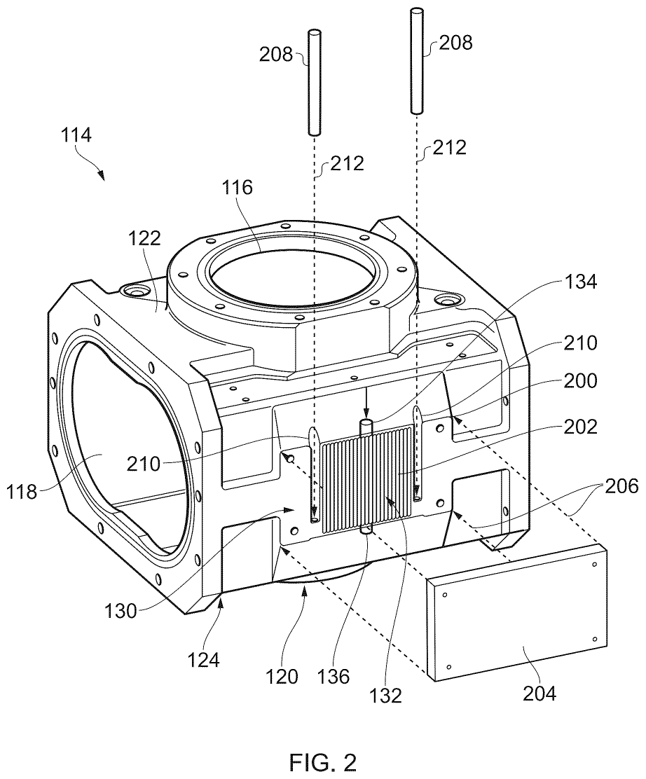

In this embodiment, the conduit 132 is a convoluted, meandering, or serpentine conduit. This can be more clearly seen in FIG. 2.

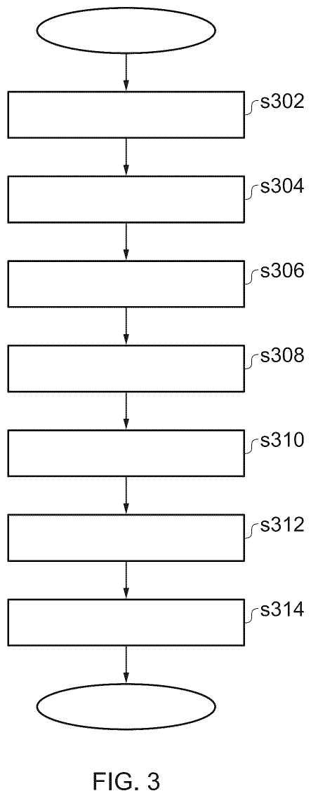

Further details of the heat exchanger 130 and its operation are described in more detail later below with reference to FIGS. 2 and 3.

The second vacuum pump 104 may be any appropriate type of vacuum pump such as a dry vacuum pump. The second vacuum pump 104 is configured to pump the fluid from the first vacuum pump 102, as indicated in FIG. 1 by an arrow and the reference numeral 112. Thus, a vacuum or low-pressure environment is created at the facility 101. The second vacuum pump 104 is configured to exhaust or output the pumped fluid, as indicated in FIG. 1 by an arrow and the reference numeral 144. The pumped fluid may be exhausted to any appropriate entity, depending on application. For example, the pumped fluid may be output to an abatement system, or to the environment.

The second vacuum pump 104 comprises a second housing or stator 146. The second stator 146 comprises one or more walls which define a second fluid inlet 148, a second pumping chamber 150, and a second fluid outlet 152.

The second vacuum pump 104 further comprises a second pumping means (not shown in the figures) located within the second pumping chamber. The second pumping means may be any appropriate type of pumping means.

The second vacuum pump 104 further comprises a nozzle 154. The nozzle 154 is disposed through the one or more walls of the second stator 146. The nozzle 154 is coupled to the conduit outlet 136 such that, in operation, a flow of purge gas is received by the nozzle 154. The nozzle 154 is further configured to deliver the received purge gas into the second pumping chamber 150, as indicated in FIG. 1 by arrows and the reference numeral 156.

FIG. 2 is a schematic illustration (not to scale) showing an exploded perspective view of the first stator 114 of the first vacuum pump 102.

In this embodiment, the heat exchanger 130 is located on a first side wall 200 of the first stator 114. The first side wall 200 is disposed between the first wall 122 and the second wall 124.

In this embodiment, the conduit 132 of the heat exchanger 130 is defined by one or more channels 202 formed on an external surface of the first side wall 200, and a cover 204 that covers the one or more channels 202, thereby to define the conduit 132.

The one or more channels 202 may be channels or grooves that have been machined or etched into the external surface of the first side wall 200. The one or more channels 202 may define one or more convolute paths between the conduit inlet 134 and the conduit outlet 136.

The cover 204 may be a substantially flat sheet or plate. The cover 204 may be formed from the same material as that from which the walls (e.g., the first side wall 200) of the first stator 114 are formed. This material may be a heat conducting material, such as a metal. The cover 204 may be attached to the first side wall 200 by any appropriate attachments means, such as using one or more fasteners. Attachment of the cover 204 to the first side wall 200 is indicated in FIG. 2 by dashed arrows and the reference numeral 206. In some embodiments, a seal or gasket, such as an O-ring, is disposed between the cover 204 and the first side wall 200 thereby to reduce or eliminate leakage of the purge gas from the heat exchanger 130.

In this embodiment, the first stator 114 further comprises two heaters 208. The heaters 208 are disposed or received in respective voids 210 in the one or more walls of the first stator 114. Thus, the heaters 208 are at least partially embedded in the first stator 114. In this embodiment, the heaters 208 and the voids 210 in which they are received are elongate. Insertion of the heaters 208 into the voids 210 is indicated in FIG. 2 by dashed arrows and the reference numeral 212.

In this embodiment, the voids 210 are formed in the first side wall 200. The voids 210 are positioned proximate the heat exchanger 130, in particular proximate the one or more channels 202. More specifically, in this embodiment, the voids 210 are positioned at opposite sides of the one or more channels 202, and adjacent to the channels 202.

The voids 210 may be defined by respective grooves formed (e.g. by machining) on an external surface of the first side wall 200, and the cover 204 that covers those grooves, thereby to define the voids 210.

The heaters 208 may be any appropriate type of heater, including but not limited to electric heaters. The heaters 208 are configured to heat, i.e. raise the temperature of, at least a portion of the one or more walls of the first stator 114. Preferably, the heaters 208 are configured to heat at least a portion of the first side wall 200 that forms conduit 132.

The heaters 208 may be controlled by a controller (not shown in the Figures). In some embodiments, the first stator 114 further comprises one or more temperature sensors, which may be disposed on or embedded in the one or more walls of the first stator 114. The one or more temperature sensors may be configured to measure a temperature of the one or more walls of the first stator. Operation of the heaters 208 may be performed based on some function of the temperature measurements taken by the one or more temperature sensors. For example, in some embodiments, the heaters 208 may be controlled to heat at least a portion of the first side wall 200 (e.g., at least a part that forms the heat exchanger 130) until a temperature of that portion of the first side wall 200, as measured by one or more temperature sensors, reaches a threshold value, at which point the heaters 208 may be controlled to stop or reduce heating. The heaters 208 may be controlled to maintain the temperature of the portion of the first side wall 200 at about the threshold value.

In some embodiments, the distribution of heaters over the first stator is such that the temperature of the first stator is substantially uniform over the body of the first stator. Heaters may be distributed over the first stator at substantially uniform intervals. The heaters may be controlled by a common controller to achieve the desired uniform temperature of the first stator.

Heaters may be distributed over the first stator in an arrangement that is substantially symmetrical about the first stator axis. One or more heaters may be located in the end covers and/or head plates of the first stator.

FIG. 3 is a process flow chart showing certain steps of a process 300 performed by the vacuum pumping system 100.

It should be noted that certain of the process steps depicted in the flowchart of FIG. 3 and described below may be omitted or such process steps may be performed in differing order to that presented below and shown in FIG. 3. Furthermore, although all the process steps have, for convenience and ease of understanding, been depicted as discrete temporally-sequential steps, nevertheless some of the process steps may in fact be performed simultaneously or at least overlapping to some extent temporally.

At step s302, the first vacuum pump 102 pumps a fluid out of the facility 101. The fluid is pumped, by the first vacuum pump 102, into the first fluid inlet 116, through the first pumping chamber 118, and out of the first fluid outlet 120. This fluid is pumped to the second vacuum pump 104 via the fluid line 110. The first vacuum pump 102 increases the pressure of the pumped fluid entering the second vacuum pump 104.

In this embodiment, the pumping of the fluid by the first vacuum pump 102 tends to cause a temperature of the one or more walls of the first stator 114 to increase above ambient temperature. This increase in temperature tends to be due to the relatively high temperature of the fluid received by the first vacuum pump 102 from the facility 101 and/or friction within the first vacuum pump 102, e.g. between the fluid and the parts of the first vacuum pump 102.

At step s304, optionally, the heaters 208 may be controlled to heat or further heat at least a portion of the one or more walls of the first stator 114. The heaters 208 may be controlled to heat at least a portion of the one or more walls of the first stator 114 to a predetermined temperature. The heaters 208 may be controlled to heat at least a portion of the first side wall 200 that forms the heat exchanger 130, i.e. the portion of the first side wall that defines the conduit 132 or one or more channels 202.

At step s306, a purge gas is pumped through the heat exchanger 130. More specifically, the purge gas is pumped from the purge gas source 106 and into the conduit 132 via the conduit inlet 134. The purge gas is then pumped through the conduit 132, from the conduit inlet 134 to the conduit outlet 136. The purge gas is then pumped out of the conduit outlet 136.

The purge gas may be pumped by any appropriate pumping means. For example, in some embodiments, the purge gas source 106 comprises a pump configured to pump the purge gas.

The purge gas may be any appropriate purge gas. Preferably, the purge gas is an inert gas. An example of a purge gas is nitrogen gas.

At step s308, as the purge gas travels through the conduit 132 of the heat exchanger 130, the heat exchanger 130 heats, i.e. increases the temperature of, the purge gas. More specifically, heat is transferred from the relatively hot first side wall 200 that at least partially forms the conduit 132, to the relatively cool purge gas flowing through the conduit 132.

Thus, in this embodiment, the temperature of the purge gas exiting the heat exchanger 130 at the conduit outlet 136 is higher than that of the purge gas entering the heat exchanger 130 at the conduit inlet 134.

In some embodiments, the heaters 208 are controlled to heat the portion of the walls of the first stator 114 that forms the heat exchanger 130 such that a temperature of the purge gas exiting the heat exchanger 130 is equal to or exceeds a predefined threshold temperature. This predefined threshold temperature may be any appropriate temperature, for example, a temperature between about 180° C. and about 250° C., or more preferably between about 180° C. and about 200° C. The predefined threshold temperature may be a temperature selected from the group of temperatures consisting of 180° C., 190° C., 200° C., 210° C., 220° C., 230° C., 240° C., and 250° C.

At step s310, the second vacuum pump 104 pumps the fluid received via the fluid line 110. The fluid is pumped, by the second vacuum pump 104, into the second fluid inlet 148, through the second pumping chamber 150, and out of the second fluid outlet 152. This fluid is pumped out of the second vacuum pump 104 to any appropriate entity, depending on application.

At step s312, the heated purge gas is pumped from the heat exchanger 130 to the second vacuum pump 104. The heated purge gas is received at the nozzle 154 of the second vacuum pump 104.

At step s314, the nozzle delivers or disperses the heated purge gas into the second pumping chamber 150 of the second vacuum pump 104. Preferably, the heated purge gas is delivered at high speed into the second pumping chamber 150.

This delivery of the heated purge gas into the second pumping chamber 150 advantageously tends to remove solid matter that has been deposited on components within the second pumping chamber 150. Such solid matter may include, by-products of processes performed by the facility 101 that may have condensed and settled within the second pumping chamber 150, or dust, etc. Advantageously, the delivery of heated purge gas into the second pumping chamber 150 tends to prevent the settling of solid particles within the second pumping chamber 150 and convey the solid particles out of the second pumping chamber 150.

The relatively high temperature of the purge gas tends to reduce or eliminate a reduction of a temperature within the second pumping chamber 150 and/or a temperature of the walls of the second stator 146 and/or the pumping means housed therein. This advantageously tends to reduce or eliminate condensation of by-products present within the pumped fluid. Accordingly, the deposition of solidified by-products within the second pumping chamber 150 tends to be reduced. The temperature within the second pumping chamber 150 and/or a temperature of the walls of the second stator 146 and/or the pumping means housed therein may be, for example, a temperature selected from the group of temperatures consisting of 180° C., 190° C., 200° C., 210° C., 220° C., 230° C., 240° C., and 250° C.

Thus, the process 300 performed by the vacuum pumping system 100 is provided.

Advantageously, the above-described system and method tends to reduce or eliminate the build-up of potentially flammable, corrosive, or otherwise hazardous particulate matter within the second vacuum pump. Furthermore, the impedance of, for example, the pumping means, e.g. rotors, of the second vacuum pump tends to be reduced or eliminated. Thus, pumping efficiency of the second vacuum pump tends to be improved.

The heating of the first stator by the heaters advantageously tends to reduce or eliminate condensation of by-products present within the pumped fluid within the first pumping chamber. Accordingly, the deposition of solidified by-products within the first pumping chamber tends to be reduced. Thus, pumping efficiency of the first vacuum pump tends to be improved.

Advantageously, uniform heating of the first stator by the heaters tends to be achieved. The net shape of the casting forming the first stator 114 tends to allow for the even placement of heaters to achieve uniform heating.

Advantageously, the above-described purge gas heating may be non-electrical, which tends to simplify the power provision on board the pump.

In the above embodiments, the first vacuum pump is a mechanical booster pump, and may be a Roots-type or Roots vacuum pump. However, in other embodiments, the first vacuum pump is a different type of vacuum pump. The first vacuum pump may have any number of stages, pumping chambers, rotors and rotor shafts, for example.

In the above embodiments, the conduit of the heat exchanger is formed in a side wall of the first stator. However, in other embodiments, the conduit is formed in one or more other walls of the first stator instead of or in addition to a side wall of the stator. For example, at least a part of the conduit may be formed in the top or bottom wall of the first stator.

In the above embodiments, the conduit is a convoluted, meandering, or serpentine conduit. However, in other embodiments, the conduit has a different appropriate shape. In some embodiments, the conduit comprises one or more features that facilitate heat transfer to the purge gas, such as one or more fins that increase the surface area of the conduit walls, and/or one or more restrictors that slow the flow of purge gas through the conduit.

In the above embodiments, the heat exchanger comprises a single conduit. However, in other embodiments, the heat exchanger comprises multiple conduits.

In the above embodiments, the first stator comprises a single heat exchanger for heating a flow of purge gas. However, in other embodiments, the first stator comprises multiple such heat exchangers.

In the above embodiments, the first stator comprises two heaters. However, in other embodiments, the stator comprises a different number of heaters, for example only one heater or more than two heaters. In some embodiments, the heaters are omitted.

In the above embodiments, the heaters are located proximate to the conduit. In particular, the heaters are adjacent to and on opposite sides of the conduit. However, in other embodiments, one or more of the heaters occupies a different position on the first stator. In some embodiments, heaters may be distributed (e.g. uniformly) over the first stator so as to provide substantially uniform heating to the walls of the first stator.

In the above embodiments, pre-heated purge gas is delivered from the first vacuum pump to the second vacuum pump, and in particular to the second pumping chamber of the second vacuum pump. However, in other embodiments, some or all of the pre-heated purge gas is delivered to a different location instead of or in addition to the second pumping chamber of the second vacuum pump. For example, in some embodiments, the heated purge gas may be delivered to respective pumping chambers of one or more further vacuum pumps in addition to the second pumping chamber of the second vacuum pump. In some embodiments, the heated purge gas is delivered to the first pumping chamber of the first vacuum pump. In some embodiments, the heated purge gas is not delivered to the second vacuum pump and the second vacuum pump may be omitted.

In the above embodiments, the conduit of the heat exchanger is defined by one or more channels and a cover that covers said channels. However, in other embodiments, the conduit is formed in a different way.

In the above embodiments, the heaters are embedded in one or more of the walls of the first stator. However, in other embodiments, the heaters are coupled to a stator wall or walls in a different way. For example, one or more of the heaters may be attached to an external surface of a wall of the first stator.

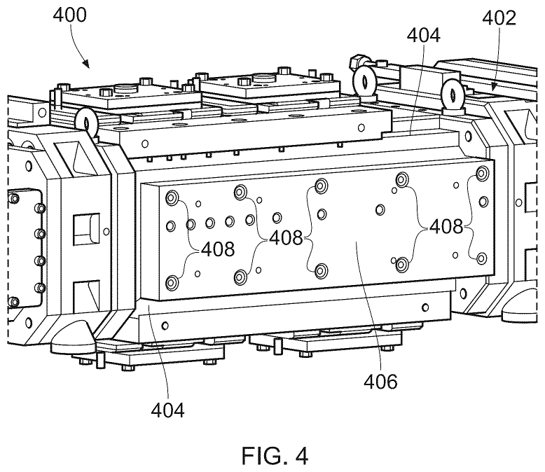

What will now be described with reference to FIGS. 4 to 8 are alternative embodiments in which the conduit of the heat exchanger through which the purge gas may flow so as to be heated is disposed in a heat transfer device, which may be removably attached to the vacuum pump stator.

FIG. 4 is a schematic illustration (not to scale) showing a perspective view of an embodiment of a vacuum pump 400.

The vacuum pump 400 may be implemented as the first vacuum pump 102 or the second vacuum pump 104 in the above embodiments.

In this embodiment, the vacuum pump 400 comprises a stator 402 comprising a plurality of stator walls 404 which define a pumping chamber.

The vacuum pump 400 further comprises a heat transfer device 406 thermally coupled to the stator 402. The heat transfer device 406 is removably attached to an external surface of one or more of the stator walls 404 by a plurality of fasteners 408.

Although FIG. 4 shows a single heat transfer device 406 disposed on a side wall of the stator 402, it will be appreciated that multiple such heat transfer devices may be implemented. One or more of the heat transfer devices may be attached to one or more other walls 404 of the stator 402, including but not limited to, external surfaces of the top, bottom, and/or side walls of the stator.

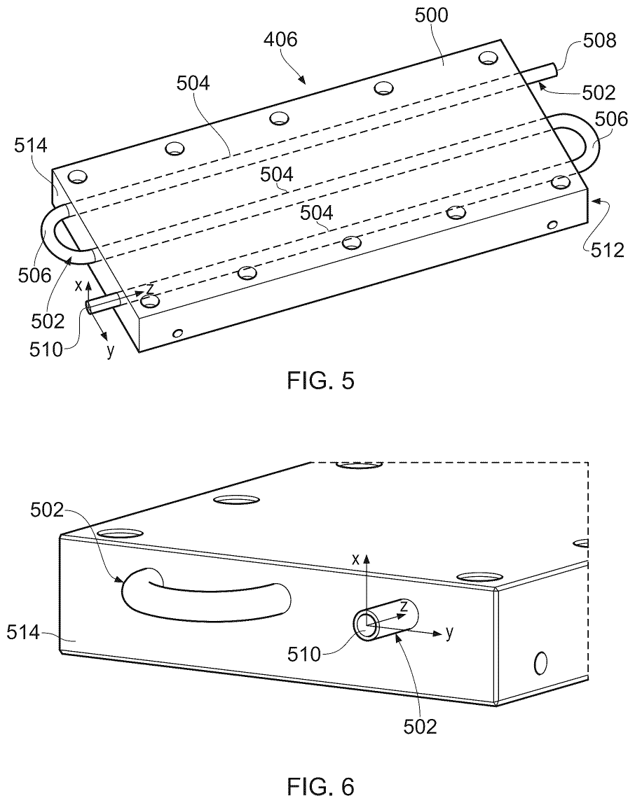

FIGS. 5 and 6 are schematic illustrations (not to scale) showing the heat transfer device 406 of this embodiment.

The heat transfer device 406 comprises a thermally conductive body 500 and a conduit 502 through the thermally conductive body.

The thermally conductive body 500 is a plate or block of a thermally conductive material. The thermally conductive body 500 may be a heat transfer plate. In this embodiment, the thermally conductive body 500 is a preferably monolithic plate of a metal, preferably aluminium or an aluminium alloy.

The conduit 502 is a pipe through which, in use, the purge gas (e.g., nitrogen) is passed whereby to heat the purge gas, such as described in more detail earlier above with reference to FIGS. 1 to 3.

The conduit 502 is a convoluted, meandering, or serpentine pipe. The conduit 502 is preferably a single-piece pipe that has been bent into a convolute or serpentine shape.

The conduit 502 is embedded within the thermally conductive body 500. In this embodiment, the conduit 502 is cast into the thermally conductive body 500, thereby to embed the conduit 502 within the thermally conductive body 500. However, in other embodiments, the conduit 502 may be embedded within the thermally conductive body 500 in a different way, such as by pressing the conduit 502 onto or into a grove formed in a surface of the thermally conductive body 500.

In this embodiment, the conduit 502 is partially embedded within the thermally conductive body 500. More specifically, a plurality of substantially straight, parallel sections 504 of the conduit 502 are embedded within the thermally conductive body 500 while curved transition sections 506 between the straight, parallel sections 504 are spaced apart from (i.e., not embedded within) the thermally conductive body 500. Nevertheless, in some embodiments, the conduit 502 may follow a convoluted path within the thermally conductive body 500. Also, in some embodiments, the conduit 502 may be wholly embedded within the thermally conductive body 500.

Preferably, the conduit 502 is formed from a different material to that from which the thermally conductive body 500 is formed. The conduit 502 may be formed from, for example, stainless steel, or a nickel-based alloy. The thermally conductive body 500 may be formed from, for example, aluminium, an aluminium alloy, or (e.g., in non-semiconductor applications) copper. Preferably, the thermally conductive body 500 is formed from a material with a thermal conductivity of greater than or equal to 200 W/mK.

In this embodiment, the conduit 502 comprises an inlet 508 and an outlet 510. The inlet 508 is arranged to receive a flow of purge gas from the purge gas supply. The purge gas received at the inlet 508 travels through the conduit 502 and exits the conduit 502 at the outlet 510.

In this embodiment, the inlet 508 is located at or proximate to a first side 512 of the heat transfer device 406. The outlet 510 is positioned at or proximate to a second side 514 of the heat transfer device 406. The second side 514 is opposite to the first side 512.

In operation, purge gas is supplied to the inlet 508 of the conduit 502 from a purge gas source, and is caused to flow through the conduit 502. Heat is transferred from the relatively hot stator to the relatively cool purge gas flowing through the conduit 502 via the thermally conductive body 500 and the walls of the conduit 502. By way of example, the thermally conductive body 500 of a heat transfer device 406 attached to the stator of a hot screw pump may be heated to a temperature of approximately 250° C. the heated purge gas exits the conduit 502 via the outlet 510. Thus, the preheating of the purge gas before it is introduced into the pumping chamber of a vacuum pump is provided.

Advantageously, the use of active electrical heating tends to be avoided, thus reducing cost and complexity. The cast in gas heating pipe tends to be a low-cost passive solution that utilises reduced space for installation and tends to be highly reliable.

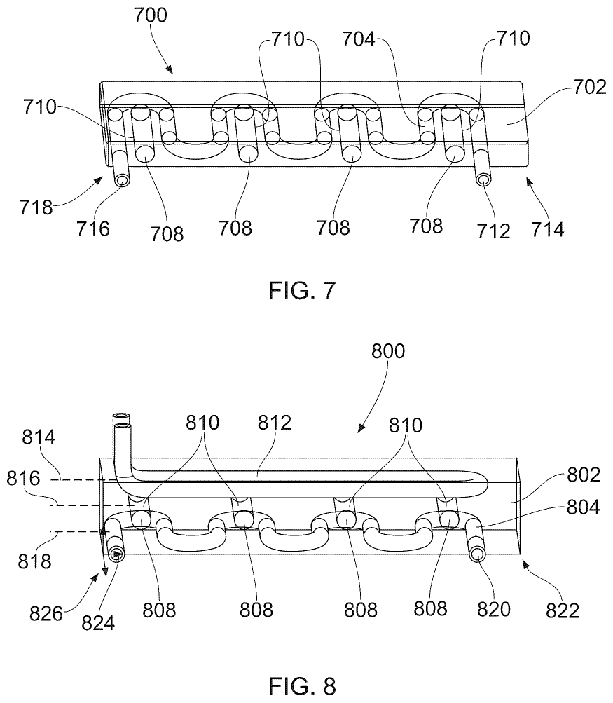

Although, the use of active heating may be avoided, nevertheless in some embodiments, the heat transfer device may further comprise one or more heaters. By way of example, FIG. 7 is a schematic illustration (not to scale) showing a heat transfer device 700 comprising one or more heaters, in accordance with a further embodiment.

The heat transfer device 700 may be thermally coupled to the stator of a vacuum pump (such as the first vacuum pump 102, or the second vacuum pump 104) in the same or a similar way to the heat transfer device 406 shown in FIG. 4. For example, the heat transfer device 700 may be removably attached to an external surface of one or more of the stator walls 404 by a plurality of fasteners.

The heat transfer device 700 comprises a thermally conductive body 702 and a conduit 704 through the thermally conductive body 702. The thermally conductive body 702 may be substantially the same as the thermally conductive body 500. For example, the thermally conductive body 702 may be a plate or block of a metal such as aluminium or an aluminium alloy.

The conduit 704 is a pipe through which, in use, the purge gas (e.g., nitrogen) is passed whereby to heat the purge gas. The conduit 704 may be a stainless-steel pipe. In this embodiment, the conduit 704 follows a convoluted path within the thermally conductive body 702. The conduit 704 comprises an inlet 712 at or proximate to a first end 714 of the heat transfer device 700, and an outlet 716 at or proximate to a second end 718 of the heat transfer device 700, the second end 718 being opposite to the first end 714. In operation, purge gas is supplied to the inlet 712 of the conduit 704 from a purge gas source, and is caused to flow through the conduit 704. Heat is transferred from the relatively hot stator to the relatively cool purge gas flowing through the conduit 704 via the thermally conductive body 702 and the walls of the conduit 704. The heated purge gas exits the conduit 704 via the outlet 716. Thus, the preheating of the purge gas before it is introduced into the pumping chamber of a vacuum pump is provided.

In this embodiment, the heat transfer device 700 further comprises a plurality of heaters 708. Although FIG. 7 shows the heat transfer device 700 comprising four heaters 708, it will be appreciated by those skilled in the art that in practice the heat transfer device 700 may comprise any number of heaters 708, such as 1, 2, 3, 4, 5, 6, 7, 8, 9, 10, or more than 10 heaters. Each heater 708 is received in a respective bore or void 710. In this embodiment, the heaters 708 and the voids 710 in which they are received are elongate. The voids 710 are formed in the thermally conductive body 702.

The heaters 708 may be any appropriate type of heater, including but not limited to electric heaters. The heaters 708 are configured to heat, i.e. raise the temperature of, at least a portion of the thermally conductive body 702.

The heaters 708 may be controlled by a controller (not shown in the Figures). In some embodiments, the heat transfer device 700 further comprises one or more temperature sensors, which may be disposed on or embedded in the thermally conductive body 702. The one or more temperature sensors may be configured to measure a temperature of the thermally conductive body 702. Operation of the heaters 708 may be performed based on some function of the temperature measurements taken by the one or more temperature sensors. For example, in some embodiments, the heaters 708 may be controlled to heat at least a portion of the thermally conductive body 702 until a temperature of that portion of the thermally conductive body 702, as measured by one or more temperature sensors, reaches a threshold value, at which point the heaters 708 may be controlled to stop or reduce heating. The heaters 708 may be controlled to maintain the temperature of the portion of the thermally conductive body 702 at about the threshold value.

In some embodiments, the distribution of heaters 708 over the thermally conductive body 702 is such that the temperature of the thermally conductive body 702 is substantially uniform. Heaters 708 may be distributed over the first stator at substantially uniform intervals. The heaters may be controlled by a common controller to achieve the desired uniform temperature of the thermally conductive body 702.

In this embodiment, the heaters 708 are arranged spaced-apart from one another. The conduit 704 is a convoluted conduit that passes through the spaces between adjacent heaters 708.

In this embodiment, the heaters 708 and the conduit 704 are arranged in a single, common layer or plane within the thermally conductive body 702. Alternatively, the heaters 708 and the conduit 704 may be arranged in different respective layers or planes within the thermally conductive body 702. By way of example, FIG. 8 is a schematic illustration (not to scale) showing a heat transfer device 800 in accordance with a yet further embodiment.

The heat transfer device 800 may be thermally coupled to the stator of a vacuum pump (such as the first vacuum pump 102, or the second vacuum pump 104) in the same or a similar way to the heat transfer device 406 shown in FIG. 4. For example, the heat transfer device 800 may be removably attached to an external surface of one or more of the stator walls 404 by a plurality of fasteners.

The heat transfer device 800 comprises a thermally conductive body 802 and a conduit 804 through the thermally conductive body 802. The thermally conductive body 802 may be substantially the same as the thermally conductive body 500 or the thermally conductive body 702. For example, the thermally conductive body 802 may be a plate or block of a metal such as aluminium or an aluminium alloy.

The conduit 804 is a pipe through which, in use, the purge gas (e.g., nitrogen) is passed whereby to heat the purge gas. The conduit 804 may be a stainless-steel pipe. In this embodiment, the conduit 804 follows a convoluted path within the thermally conductive body 802. The conduit 804 comprises an inlet 820 at or proximate to a first end 822 of the heat transfer device 800, and an outlet 824 at or proximate to a second end 826 of the heat transfer device 800, the second end 826 being opposite to the first end 822. In operation, purge gas is supplied to the inlet 820 of the conduit 804 from a purge gas source, and is caused to flow through the conduit 804. Heat is transferred from the relatively hot stator to the relatively cool purge gas flowing through the conduit 804 via the thermally conductive body 802 and the walls of the conduit 804. The heated purge gas exits the conduit 804 via the outlet 824. Thus, the preheating of the purge gas before it is introduced into the pumping chamber of a vacuum pump is provided.

In this embodiment, the heat transfer device 800 further comprises a plurality of heaters 808. Although FIG. 8 shows the heat transfer device 800 comprising four heaters 808, it will be appreciated by those skilled in the art that in practice the heat transfer device 800 may comprise any number of heaters 808, such as 1, 2, 3, 4, 5, 6, 7, 8, 9, 10, or more than 10 heaters. Each heater 808 is received in a respective bore or void 810. In this embodiment, the heaters 808 and the voids 810 in which they are received are elongate. The voids 810 are formed in the thermally conductive body 802.

The heaters 808 may be any appropriate type of heater, including but not limited to electric heaters. The heaters 808 may be controlled by a controller, for example using sensor measurements, as described in more detail earlier above with respect to, for example, FIG. 7.

In this embodiment, the heaters 808 and the conduit 804 are arranged in different respective layers or planes within the thermally conductive body 802. The planes or layers may be substantially parallel with each other.

In this embodiment, the heat transfer device 800 further comprises a further conduit 812. The further conduit 812 is a pipe through the thermally conductive body 802 and through which, in use, a cooling fluid (e.g., water) is passed whereby to cool the thermally conductive body 802. The further conduit 812 is preferably a convoluted, meandering, or serpentine conduit. The further conduit 812 may be considered to be a cooling fluid conduit. It will be appreciated by those skilled in the art that such a cooling fluid conduit may be implemented in any of the other embodiments of the heat transfer device described herein, such as the heat transfer device 406 described in more detail earlier above with respect to FIGS. 5 and 6, or the heat transfer device 700 described in more detail earlier above with respect to FIG. 7.

In this embodiment, the further conduit 812 is arranged in the thermally conductive body 802 in a first layer 814. For example, the further conduit 812 may be disposed in a first plane. Also, the plurality of heaters 808 are arranged in the thermally conductive body 802 in a second layer 816. For example, the plurality of heaters 808 may be disposed in a second plane. Also, the conduit 804 is arranged in the thermally conductive body 802 in a third layer 818. For example, the conduit 804 may be disposed in a third plane. Preferably the first, second, and third layers (or planes) 814, 816, 818 are substantially parallel with each other. In this embodiment, the second layer 816 is disposed between the or first layer 814 and the third layer 818. That is to say, the layer of heaters 808 is sandwiched between the layer or plane containing the further conduit 812 and the layer or plane containing the conduit 804. The heat transfer device 800 may be attached to the stator walls such that the third layer 818 is in contact with the stator wall, and the first layer 814 is furthest from the stator.

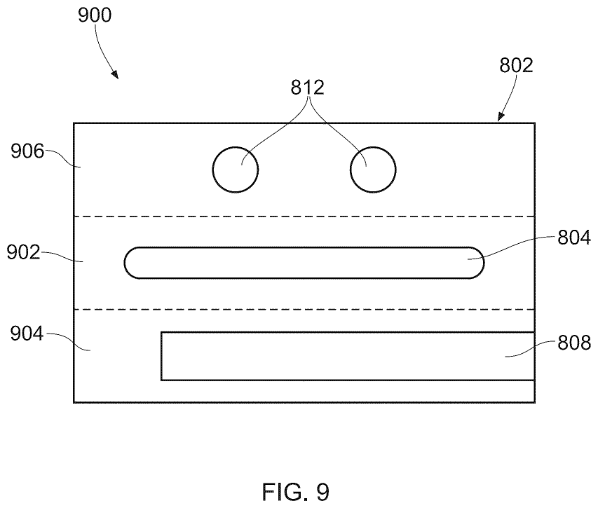

Nevertheless, in other embodiments, the ordering or arrangement of the layers may be different. By way of example, FIG. 9 is a schematic illustration (not to scale) showing a cross section of a heat transfer device 900 in which the conduit 804, the heaters 808, and the further conduit 812 are arranged differently. In this embodiment, the layer or plane 902 containing the conduit 804 is sandwiched between the layer 904 of heaters 808 and the layer or plane 906 containing the further conduit 812. The heat transfer device 900 may be attached to the stator walls such that the layer 904 containing the heaters 808 is in contact with the stator wall, and the layer or plane 906 containing the further conduit 812 is furthest from the stator. In this arrangement, the heat loss upwards from the heaters 808 tends to be captured by the purge gas within the conduit 804, and also the heaters 808 are in close proximity or direct contact with the stator to provide more effective heating thereof. In the case where the heaters 808 are on and the cooling fluid supply to the further conduit 812 is off, the purge gas tends to provide a protection layer between the heaters 808 and the further conduit 812 to prevent the cooling fluid boiling, stress corrosion and calcification within the further conduit 812.

The above-described heat transfer devices tend to prevent or reduce calcification and stress corrosion. For example, the purge gas flowing through the conduit 804 tends to prevent the cooling fluid (e.g. the water) within the further conduit 812 from boiling tends to be beneficial in preventing calcification and stress corrosion problem for a static cooling plate when water does not flow internally.

In operation, when cooling of the stator is required, the one or more heaters may be turned off, and the flow of purge gas and cooling fluid may be turned on. In operation, when heating of the stator and/or purge gas is required, the flow of cooling fluid may be turned off and the one or more heaters and the flow of purge gas may be turned on.

Advantageously, the above-described systems and apparatus tend to provide for a vacuum pump system having reduced footprint. For example, a need for additional, separate purge gas heating apparatus may be reduced or eliminated.

The above-described heat transfer devices tend to provide for relatively low power consumption, and/or provide a more uniform temperature distribution across the pump.

The above-described systems and apparatus tend to provide shorter pump warm up times by preheating the purge gas. If the purge gas is supplied to an abatement system, this also saves power to preheat the purge gas in the abatement system.

Advantageously, above-described systems and apparatus tend to allow for the use of more powerful heaters. This tends to provide improved preheating of the purge gas and heating of the stator, thus proving for shorter pump warm up times.

The purge gas flowing through the purge gas conduit tends to distribute over the stator, reducing the likelihood of hot/cold spots resulting from local heating by the heaters.

In the above-described systems and apparatus, the purge gas conduit can be arranged so that the purge gas flows along a length od the stator between a low vacuum end of the stator and low vacuum end of the stator. For example, the above-described heat transfer devices may be attached to the stator such that the inlet of the conduit is located at or proximate to one of the high-vacuum end or the low vacuum end of the vacuum pump, and the outlet of the conduit is located at or proximate to the other one of the high-vacuum end or the low vacuum end. In operating conditions, such as high load conditions, where stages at and proximate to the high-vacuum end of the vacuum pump are potentially hotter than stages at and proximate to the low-vacuum end of the vacuum pump, purge gas could be caused to enter the purge gas conduit at the conduit opening nearer the high-vacuum end; the flow of purge gas through the conduit would tend to transfer heat from the high-vacuum end to the cooler low-vacuum end. Similarly, in operating conditions, such as under ultimate condition, where stages at and proximate to the low-vacuum end of the vacuum pump are potentially hotter than stages at and proximate to the high-vacuum end of the vacuum pump, purge gas could be caused to enter the purge gas conduit at the conduit opening nearer the low-vacuum end; the flow of purge gas through the conduit would tend to transfer heat from the low-vacuum end to the cooler high-vacuum end. Advantageously, the direction of purge gas flow through the conduit tends to be changeable.

In the above embodiments, the purge gas conduit may have any appropriate dimensions. For example, the purge gas conduit may have an internal diameter of about 5-10 mm, or more preferably about 6 mm. In some embodiment, the purge gas conduit may have an internal diameter of less than or equal to 5 mm, for example 2-4 mm, e.g. about 3 mm.

In the above embodiments, the thermally conductive body of a heat transfer device may be cast or machined. However, in other embodiments, at least a part of the heat transfer device, such as the thermally conductive body, may be fabricated in a different way, such as using Additive Manufacturing (AM) techniques. For example, a thermally conductive body may be formed using AM to include a network of purge gas conduits therein. Having smaller purge gas conduits in the heat transfer device tend to provide for improved prevention of calcification and stress corrosion.

In the above embodiments, the purge gas may be nitrogen. However, in other embodiments, a different purge gas may be used, such as air.

In the above embodiments, the cooling fluid may be water. However, in other embodiments, a different cooling fluid may be used.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are described as example forms of implementing the claims.

1. A vacuum pump comprising:
a stator, the stator comprising one or more stator walls defining a pumping chamber; and
a heat transfer device coupled to the one or more stator walls, the heat transfer device comprising:
a thermally conductive body; and
a conduit through the thermally conductive body and through which, in use, a purge gas is passed whereby to heat the purge gas.

2. The vacuum pump of claim 1, wherein the heat transfer device is attached to an external surface of the one or more stator walls.

3. The vacuum pump of claim 1, wherein the conduit comprises a pipe that is embedded within the thermally conductive body.

4. The vacuum pump of claim 3, wherein the pipe is a stainless-steel pipe.

5. The vacuum pump of claim 1, wherein the thermally conductive body is a plate of a thermally conductive material.

6. The vacuum pump of claim 1, wherein the thermally conductive body comprises aluminium.

7. The vacuum pump of claim 1, wherein the heat transfer device further comprises one or more heaters embedded therein.

8. The vacuum pump of claim 7, wherein:
the heat transfer device comprises a plurality of heaters arranged spaced-apart from one another; and
the conduit is a convoluted conduit passing through one or more spaces between the heaters.

9. The vacuum pump of claim 1, wherein the conduit is a convoluted conduit.

10. The vacuum pump of claim 1, wherein the heat transfer device further comprises:
a further conduit through the thermally conductive body and through which, in use, a cooling fluid is passed whereby to cool the thermally conductive body.

11. The vacuum pump of claim 1, wherein the heat transfer device comprises:
a further conduit through the thermally conductive body arranged to receive a cooling fluid whereby to cool the thermally conductive body, wherein the further conduit is arranged in the thermally conductive body as a first layer; and
a plurality of heaters arranged in the thermally conductive body as a second layer; wherein
the conduit is arranged in the thermally conductive body as a third layer; and
the third layer is disposed between the first layer and the second layer.

12. The vacuum pump of claim 1, wherein the conduit comprises:
an inlet at or proximate to a first side of the heat transfer device; and
an outlet at or proximate to a second side of the heat transfer device, the second side being opposite to the first side.

13. The vacuum pump of claim 1, wherein:
the stator comprises a high-vacuum end and a low vacuum end;
the conduit comprises:
an inlet at or proximate to one of the high-vacuum end or the low vacuum end; and
an outlet at or proximate to the other one of the high-vacuum end or the low vacuum end.

14. A system comprising:
the vacuum pump of claim 1; and
a purge gas source configured to supply the purge gas into the conduit.

15. A method comprising:
providing a vacuum pump, the vacuum pump being in accordance with claim 1;
pumping, using the vacuum pump, a fluid, the fluid being pumped through the pumping chamber of the vacuum pump; and
causing a purge gas to flow through the conduit of the heat transfer device; wherein
as the purge gas flows through the conduit, heat is transferred to the purge gas from the stator via the thermally conductive body, thereby to heat the purge gas.
